(19) United States
(12) Patent Application Publication
(10) Pub. No.: US 2005/0068358 A1
(43) Pub. Date: Mar. 31, 2005

(54) Inkjet printing device

(75) Inventor: Toshiaki Mizutani, Kasugai-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/951,800

(22) Filed: Sep. 29, 2004

(30) Foreign Application Priority Data
Sep. 30, 2003 (JP) 2003-340524

(51) Int. Cl. B41J 29/38

(52) U.S. Cl. 347/14

(57) ABSTRACT

An inkjet printing device, which is provided with a holding unit that is used to hold a substrate to be subjected to printing operation, an inkjet head that ejects ink onto the substrate held by the holding unit, and a controller that moves the holding unit relative to the inkjet head to perform the printing operation. In this structure, the controller operates to wait a predetermined stopping time after the holding unit is moved to start ejecting the ink onto the substrate held on the holding unit. The predetermined stopping time is determined depending on at least one factor that determines a time period required for mechanical vibrations of the holding unit caused by movement of the holding unit to decrease to a negligible level.

### BACKGROUND OF THE INVENTION

The present invention relates to an inkjet printing device used for printing images such as photographs or designs on a substrate. In particular, the present invention relates to a configuration of the inkjet printing device for preventing deterioration of imaging quality due to mechanical vibrations of a platen.

Inkjet printing devices for forming images or designs on the substrate including fabric and a sheet are widely used. In U.S. Pat. No. 6,095,628, an inkjet printing device for the fabric is disclosed. The inkjet printing device in this US patent includes a platen which has a plate-like form and is mounted in the inkjet printing device movably in a front and rear direction, and an inkjet head for ejecting ink toward the platen.

A user loads a T-shirt as the substrate onto the platen from the front side of the inkjet printing device. Then, printing operation is started. During the printing operation, the platen holding the T-shirt is moved relative to the ink-jet head so that a printing position on the T-shit is shifted. After the printing operation is finished, the T-shirt is detached from the platen on the front side of the inkjet printing device.

### SUMMARY OF THE INVENTION

One of problems of the inkjet printing device disclosed in the above mentioned US patent document is that mechanical vibrations of the platen are caused as the platen moves during the printing operation because the platen is supported by supporting rods in the inkjet printing device. Such mechanical vibrations of the platen may deteriorate imaging quality.

One of techniques to solve such a problem is to drive the platen such that the platen is stopped for a predetermined time period after the platen is moved so as to wait until the mechanical vibrations decreases. After the predetermined time period has elapsed, ink ejection from the inkjet head is started while the platen is stopped. With this technique, the deterioration of the imaging quality can be avoided.

However, the amplitude of the mechanical vibrations changes with the printing position on the platen, and therefore a time period, for which the amplitude of the mechanical vibrations decrease to a negligible level, also changes depending on the printing position on the platen. More specifically, the time period for which the mechanical vibrations decrease to the negligible level becomes longer at a point farther from a position of the supporting rod.

The printing operation may start before the amplitude of the mechanical vibrations decreases to the negligible level if the predetermined time period is relatively short, by which the imaging quality is deteriorated.

On the other hand, if the predetermined time period is relatively long, the deterioration of the imaging quality can be avoided. However, in this case, a printing time required to finish the printing operation becomes long, which reduces the production efficiency.

The present invention is advantageous in that it provides an inkjet printing device which is capable of preventing deterioration of imaging quality due to mechanical vibrations of a platen.

According to an aspect of the invention, there is provided an inkjet printing device, which is provided with a holding unit that is used to hold a substrate to be subjected to printing operation, an inkjet head that ejects ink onto the substrate held by the holding unit, and a controller that moves the holding unit relative to the inkjet head to perform the printing operation. In this structure, the controller operates to wait a predetermined stopping time after the holding unit is moved to start ejecting the ink onto the substrate held on the holding unit. The predetermined stopping time is determined depending on at least one factor that determines a time period required for mechanical vibrations of the holding unit caused by movement of the holding unit to decrease to the negligible level.

Since the predetermined stopping time is determined depending on the at least one factor that determines the time period required for the mechanical vibrations of the holding unit to decrease to the negligible level, deterioration of image quality due to the mechanical vibrations of the holding unit can be prevented and the predetermined stopping time more than necessity is not used.

Optionally, the inkjet printing device may include a detecting system that detects a type of the holding unit. In this case, the at least one factor includes the type of the holding unit detected by the detecting system.

Still optionally, the type of the holding unit may change in accordance with a shape and material of the holding unit.

Still optionally, the inkjet printing device may include a supporting member that is used to support the holding unit. In this case, the at least one factor includes a distance between a printing position at which the ink is ejected toward the holding unit and a position of the supporting member on the holding unit.

Still optionally, the at least one factor may include an amount of movement of the holding unit.

In a particular case, the controller may operate to move the holding unit by a distance corresponding to one line of an image to be printed each time printing of one of lines of the image is completed. The controller waits the predetermined time period after the holding unit is moved by the distance corresponding to the one line.

Optionally, the distance corresponding to the one line may change depending on resolution of the image to be printed, and the at least one factor may include the resolution of the image.

In a particular case, the controller may have a time table in which a plurality of stopping times are defined. The plurality of stopping times are associated with the at least one factor so that the controller selects one of the stopping times as the predetermined stopping time in accordance with the at least one factor.

In a particular case, the inkjet printing device may include an operation panel that has buttons for inputting information to the controller. In this case, the at least one factor is inputted to the controller manually by use of the operation panel.

According to another aspect of the invention, there is provided a method of printing an image on a substrate held on a holding unit provided in an inkjet printing device. The method includes moving the holding unit relative to an ink-jet head, determining a stopping time depending on at least one factor that determines a time period required for mechanical vibrations of the holding unit caused by movement of the holding unit to decrease to a negligible level, waiting the stopping time after the holding unit is moved in the moving step, and starting to eject ink on the substrate held on the holding unit after the stopping time has elapsed in the waiting step.

Since the stopping time is determined depending on the at least one factor that determines the time period required for the mechanical vibrations of the holding unit to decrease to a negligible level, deterioration of imaging quality due to the mechanical vibrations of the holding unit can be prevented and the stopping time more than necessity is not used.

According to another aspect of the invention, there is provided a method of printing an image on a substrate held on a holding unit detachably attached to an inkjet printing device. The method includes detecting a type of the holding unit attached to the inkjet printing device, moving the holding unit relative to an inkjet head, and determining a stopping time depending on at least one factor that determines a time period required for mechanical vibrations of the holding unit caused by movement of the holding unit to decrease to a negligible level. The method further includes waiting the predetermined stopping time after the holding unit is moved in the moving step, and starting to eject ink on the substrate held on the holding unit after the stopping time has elapsed in the waiting step. The at least one factor includes the type of the holding unit detected by the detecting step.

Since the stopping time is determined depending on the at least one factor that determines the time period required for the mechanical vibrations of the holding unit to decrease to a negligible level, deterioration of imaging quality due to the mechanical vibrations of the holding unit can be prevented and the stopping time more than necessity is not used.

### BRIEF DESCRIPTION OF THE ACCOMPANYING DRAWINGS

FIG. 1 is a front view of an inkjet printing device according to an embodiment of the invention;

FIG. 2 is a side view of the inkjet printing device;

FIG. 3 shows a situation in which a platen is attached to a supporting rod when the platen and the supporting rod are viewed as a side view;

FIG. 4 shows a situation in which the platen is attached to the supporting rod when the platen and the supporting rod are viewed as a top view;

FIG. 5 shows a scanning path on a top surface of the platen;

FIG. 6 shows an electrical block diagram of the inkjet printing device according to the embodiment;

FIG. 7 schematically shows storing areas in a ROM shown in FIG. 6:

FIG. 8 schematically shows storing areas in a RAM shown in FIG. 6;

FIG. 9 shows a platen type table stored in the ROM;

FIG. 10 shows an example of a determination table for determining a required stop time table;

FIG. 11 shows an example of a stop time table:

FIG. 12 is a flowchart illustrating a process of printing; and

FIG. 13 is a flowchart illustrating a printing process performed by the inkjet printing device under control of a control unit.

### DETAILED DESCRIPTION OF THE EMBODIMENTS

Hereafter, an embodiment according to the invention will be described with reference to the accompanying drawings.

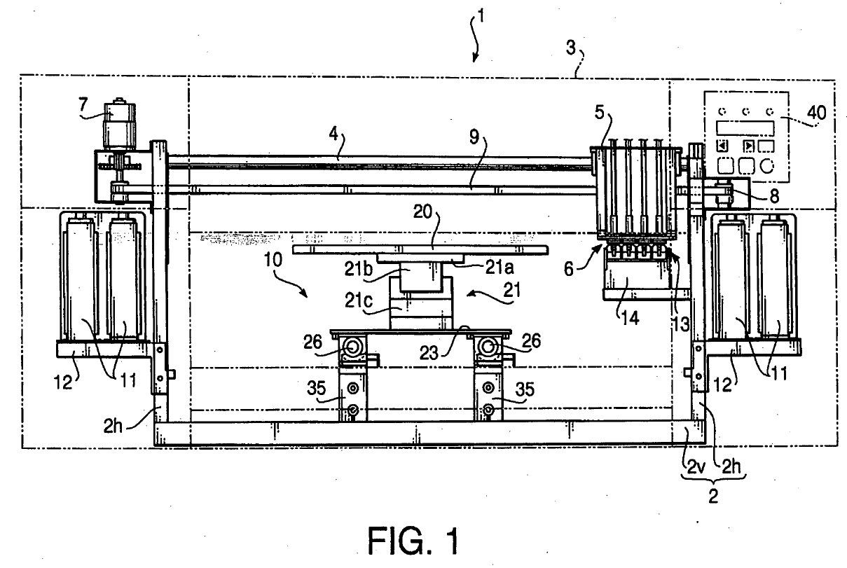

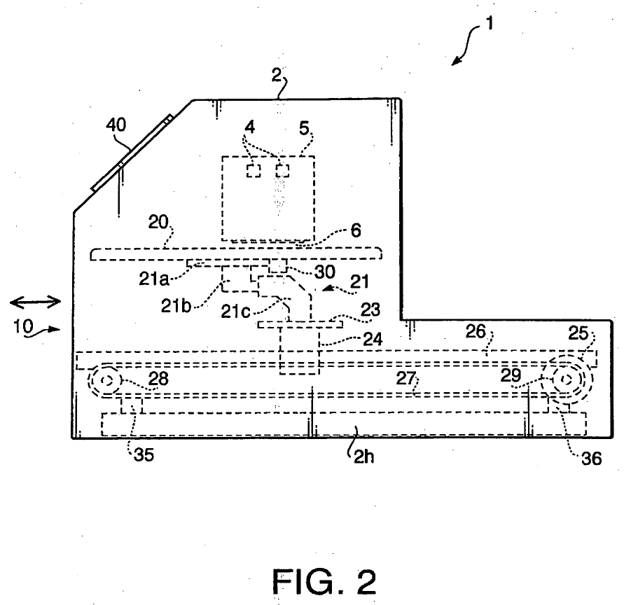

FIG. 1 is a front view of an inkjet printing device 1 according to the embodiment of the invention. FIG. 2 is a side view of the inkjet printing device 1. The left side in FIG. 2 corresponds to the front side of the inkjet printing device 1.

As shown in FIG. 1, the inkjet head printer 1 has a frame 2 including a horizontal part 2v located at the bottom of the inkjet printing device 1 and vertical parts 2h protruding upwardly in the vertical direction at both end portions of the horizontal part 2v. A guide rail 4 is attached to the tops of the right and left vertical parts 2h. The guide rail 4 is used to guide a carriage 5 accommodating inkjet heads 6 in a lateral direction (i.e., a longitudinal direction of the guide rail 4).

At the left end portion of the guide rail 4, a carriage motor 7 is located. At the right end portion of the guide rail 4, a pulley 8 is located. A carriage belt 9 is hung on a driving shaft of the carriage motor 7 and the pulley 8 to be driven by driving force of the carriage motor 7. The carriage 5 is fixed to the carriage belt 9 at the rear side thereof to be moved along the guide rail 4. That is, the carriage 5 reciprocates along the guide rail 4 in the lateral direction.

A casing 3 is attached to the frame 2 to cover and protect internal components of the inkjet printing device 1. In FIG. 1, the casing 3 is indicated by chain lines to show the internal components. As shown in FIG. 1, an operation panel 40 is provided at the upper right side of the front surface of the casing 3.

The carriage 5 accommodates four inkjet heads 6 respectively corresponding to four color components of cyan, magenta, yellow and black. Each inkjet head 6 has 128 ejection channels (not shown) for ejecting ink. Each ejection channel has a piezoelectric actuator. The piezoelectric actuators provided for the ejection channels are selectively driven to eject ink downwardly from desired ones of nozzles provided at tip portions of the ejection channels.

Cartridge casings 12, to which two ink cartridges 11 are detachably attached, are located on right and left side surfaces of the frame 2. The ink is supplied to inkjet heads 6 from the ink cartridges 11, respectively, via tubes (not shown).

At the right end position of the guide rail 4, a purge unit 14 having a suction cap 13 is located. When the cartridge 20 is located at the right end position, the suction cap 13 closely contacts with nozzle-surfaces (on which the nozzles are formed) of the inkjet heads 6. When the suction cap 13 contacts with the nozzle surfaces of the inkjet heads 6, head cleaning of the inkjet heads 6 is conducted by suctioning the ink from the nozzle surfaces through the suction cap 13 by a suction pump (not shown) provided in the purge unit 14.

Since the nuzzle surfaces are covered with the suction cap 13 when the printing operation is not performed, drying of the ink on the nozzle surface is prevented.

As shown in FIGS. 1 and 2, a platen driving mechanism 10 is mounted on the horizontal part 2v. The platen driving mechanism 10 will be explained below. At the front side of the horizontal part 2v, a pair of bases 35 are fixed to protrude upwardly from the horizontal part 2v in the vertical direction. At the rear side of the horizontal part 2v, a pair of bases 36 are fixed to protrude upwardly from the horizontal part 2v in the vertical direction. By the four bases 35 and 36 as vertexes, a rectangular shape is formed when the four bases 35 and 36 are viewed along the vertical direction.

Above the top ends of the bases 35, pulleys 28 are located. Further, above the top ends of the base 36, pulleys 29 are located. An endless belt 27 is hung on the right side pulley 28 and the right side pulley 29. Another endless belt 27 is also hung on the left side pulley 28 and the left side pulley 29.

Platen rails 26 are located above the two endless belts 27, respectively. A slide base 23 is attached to the platen rails 26 and the endless belts 27 via a fixing unit 24. On the slide base 23, a supporting rod 21 is mounted to support a platen 20 on its upper side. Further, a platen motor 25 is provided to rotate the pulleys 29.

In this structure, the fixing unit 24 is moved along the platen rails 26 by the driving force of the platen motor 25. That is, the fixing unit reciprocates in the front and rear direction of the inkjet printing device 1.

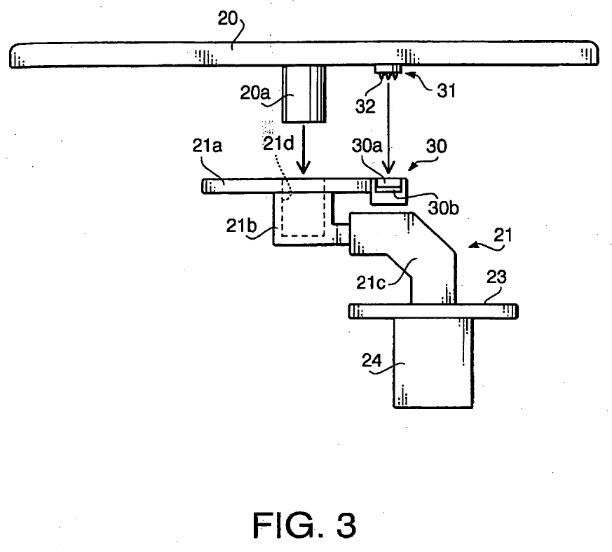

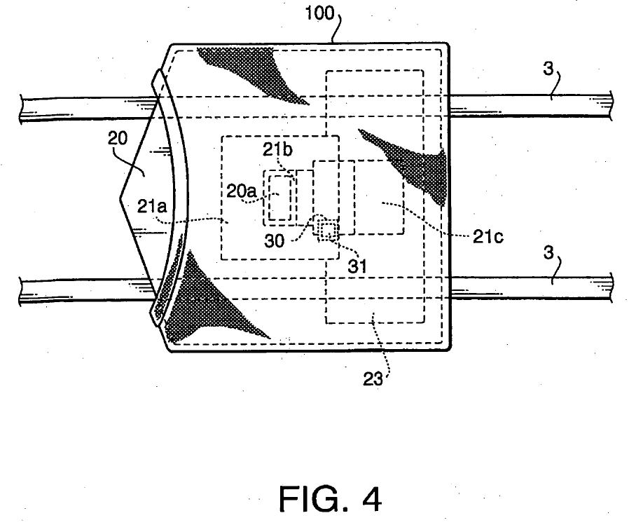

Next, installation of the platen 20 to the supporting rod 21 will be explained with reference to FIGS. 3 and 4. FIG. 3 shows a situation in which the platen 20 is attached to the supporting rod 21 when the platen 20 and the supporting rod 21 are viewed as the side view. FIG. 4 also shows the situation in which the platen 20 is attached to the supporting rod 21 when the platen 20 and the supporting rod 21 are viewed as the top view.

The platen 20 is configured to be a plate-like member. As shown in FIG. 4, the platen 20 has a substantially rectangular form of which front side corners are cut so that the front end portion thereof has a form of a letter “V”. With this shape of the platen 20, the user can easily load the T-shirt onto the platen 20.

Although in this embodiment the platen 20 is configured to have the shape shown in FIG. 4, the platen 20 may be configured to have another shape. For example, the shape and the size of the platen 20 may be determined based on a shape of a printed portion of a substrate (e.g., the T-shirt).

It is understood from FIG. 4 that the shape of the platen 20 of this embodiment is convenient for printing images onto a body portion of the T-shirt.

As shown in FIG. 3, a protrusion 20a is formed at a central portion of the bottom surface of the platen 20. By fitting the protrusion 20a into a fitting hole 21d of the supporting rod 21, the platen 20 is fixed to the supporting rod 21. Further, on the bottom surface of the platen 20, an identification unit 31 used to identifying the type of the platen 20 is attached.

More specifically, the identification unit 31 has a plurality of projections 32. Since the number of projections 32 and positions of the projections 32 in the identification unit 31 change depending on the type of the platen 20, the type of the platen attached to the supporting rod 21 can be determined by detecting the projections 32.

The supporting rod 21 has a receiving plate 21a, a connection member 21b and a support base 21c. The support base 21 is configured such that it protrudes upwardly in the vertical direction from the upper surface of the slide base 23, protrudes toward the front side with an angle of 45° being formed with respect to a horizontal direction, and further protrudes toward the front side in the horizontal direction.

The connection member 21b is an L-shape member. The connection member 21b is configured such that it protrudes in the horizontal direction from a front side end of the support base 21c, and then expands upwardly in the vertical direction. At the top end of the connection member 21b, the receiving plate 21a is attached. A portion of the connection member 21b attached to the front side end of the support base 21c has a cross section smaller than that of the front side end of the support base 21c.

As shown in FIG. 3, an opening is formed at a central position of the receiving plate 21a and a hole is formed on the connection member 21b at a position corresponding to the opening of the receiving plate 21a, so that the fitting hole 21d into which the protrusion 20a is fitted is formed.

At the rear side of the receiving plate 21a, a sensor unit 30 is located. The sensor unit 30 has a hole 30a into which the identification unit 31 is fitted. At the bottom of the hole 30a of the sensor unit 30, a photo sensor 30b is located. When protrusion 20a of the platen 20 is fitted into the fitting hole 21d of the supporting rod 21, the identification unit 31 is also fitted into the hole 30a and the projections 32 of the identification unit 31 are detected by the photo sensor 30b of the sensor unit 30.

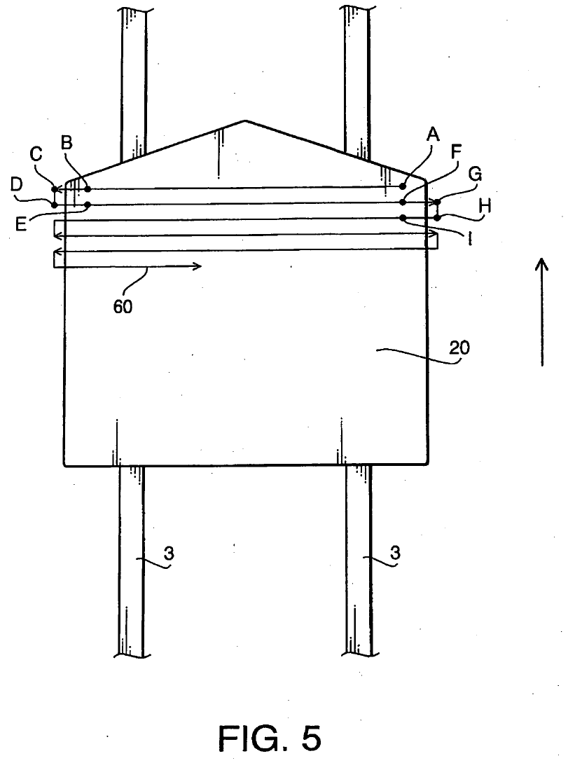

FIG. 5 shows a scanning path 60 on the top surface of the platen 6. The scanning path 60 is formed by the movement of the platen 6 in the front and rear direction and the movement of the inkjet head 6 in the lateral direction. In FIG. 5, the platen 20 is shown as the top view. The upper side of FIG. 5 corresponds to the front side of the inkjet printing device 1.

As described above, the carriage 5 accommodating the inkjet heads 6 reciprocates in the lateral direction along the guide rail 4. On the other hand, the platen 20 moves toward the front side (i.e., the upward direction in FIG. 5) in the front and rear direction of the inkjet printing device 1. In other words, the carriage 5 does not move in the front and rear direction, and the platen 26 does not move in the lateral direction.

When the printing operation is initiated, the platen 20 is moved to the rear end position (i.e., a start position) and the inkjet head 6 is moved to a print start point A at the left end portion of the guide rail 4. Then, the inkjet head 6 moves leftward in FIG. 5 from the start point A to an endpoint B while ejecting the ink onto the T-shirt held on the platen 20. Thus, printing for a first line is finished. After the printing for the first line is finished, the inkjet head 6 further moves leftward in FIG. 5 to a point C away from the platen 20.

Next, the platen 20 moves toward the front side by a distance corresponding to one line, so that the inkjet head 6 moves downwardly in FIG. 5 to a point D. After the movement of the platen 20 corresponding to one line is finished, the inkjet head 6 moves to a print stat point E. Then, the ink-jet head 6 moves rightward in FIG. 5 from the stat point E to an endpoint F while ejecting the ink onto the T-shirt. Thus, printing for a second line is finished. After the printing for the second line is finished, the inkjet head 6 further moves rightward in FIG. 5 to a point G away from the platen 20.

Next, the platen 20 moves toward the front side by a distance corresponding to one line, so that the inkjet head 6 moves downwardly in FIG. 5 to a point H. After the movement of the platen 20 corresponding to one line is finished, the inkjet head 6 moves to a print stat point I. It is noted that the print start point I is equal to the print stat point A with regard to the position of the inkjet head 6 along the guide rail 4.

Such printing operation is continued along the scanning path 60 on the platen 20. It should be noted that the distance corresponding to one line changes depending on resolution of the image to be printed. When an area in which the image is printed is constant, the distance corresponding to one line decreases as the resolution increases, and the distance corresponding to one line increases as the resolution decreases.

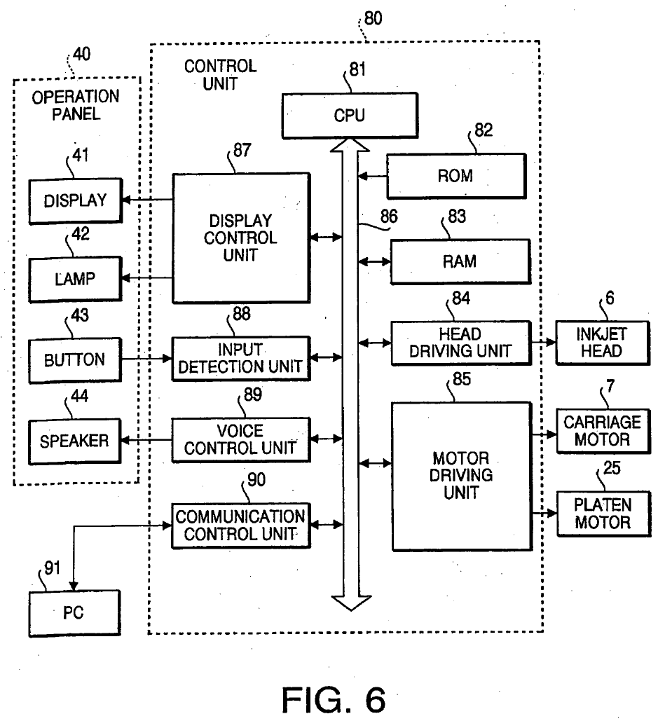

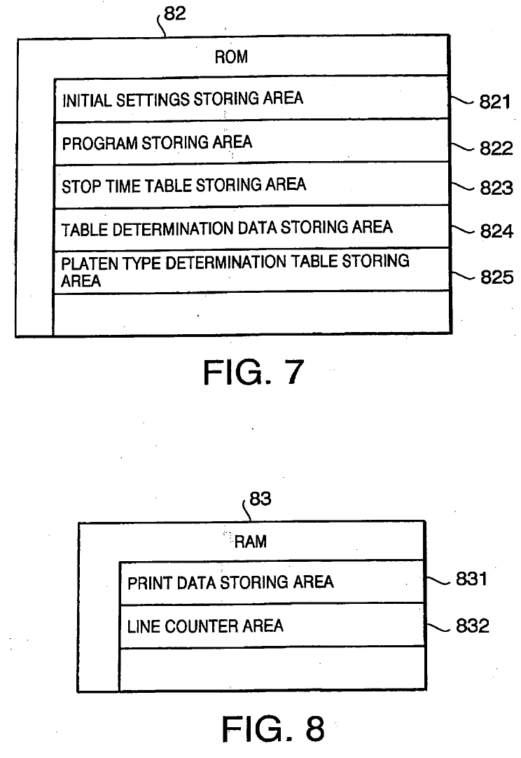

Hereafter, a control system of the inkjet printing device 1 will be described. FIG. 6 shows an electrical block diagram of the inkjet printing device 1 according to the embodiment. FIG. 7 schematically shows storing areas in a ROM 82. FIG. 8 schematically shows storing areas in a RAM 83.

As shown in FIG. 6, the inkjet printing device 1 has a control unit 80 including a CPU (central processing unit) 81 for controlling various kinds of operation of the ink-jet printing device 1. The control unit 8 further includes the ROM 82 storing various programs to be executed by the CPU 81, and the RAM 83 used to storing various types of data temporarily.

Further, the control unit 80 includes a head driving unit 84 which drives the piezoelectric actuators provided for the ejection channels, and a motor driving unit 85 which drives the carriage motor 7 and the platen motor 25. The ROM 82, the RAM 83, the head driving unit 84 and the motor driving unit 85 are connected to the CPU 81 via a bus 86.

Further, the control unit 80 includes a display control unit 87 which controls a display 41 and a lamp 42 provided on the operation panel 40, an input detection unit 88 which receives input from various buttons 43 provided on the operation panel 40, and a voice control unit 89 which controls a speaker 44 provided on the operation panel 44 to conduct voice output operation.

The control unit 80 further includes a communication control unit 90 which operates to communicate with an external device such as a personal computer (PC) 91. The display control unit 87, the input detection unit 88, the voice control unit 89 and the communication control unit 90 are connected to the CPU 81 via the bus 86.

As shown in FIG. 7, in the ROM 82, an initial settings storing area 821, a program storing area 822, a stop time table storing area 823, a table determination data storing area 824 and a platen type determination table storing area 825 are assigned.

In the initial settings storing area 821, various types of initial settings used for the programs stored in the ROM 82 are stored. In the program storing area 822, various types of programs for controlling the inkjet printing device 1 are stored. In the stop time table storing area 823, stop time tables are stored. In the table determination data storing area 824, a determination table for determining a required stop time table is stored. In the platen type determination table storing area 825, a platen type table for determining the type of the platen is stored.

As shown in FIG. 8, in the RAM 83, a print data storing area 831 and a line counter area 832 are assigned. In the print data storing area 831, print data received from the PC 91 are stored. In the line counter area 832, the count indicating the number of printed lines is stored.

As described above, the platen 20 vibrates with respect to the supporting rod as an axis of the vibration motion when the platen 20 moves during the printing operation.

Considering that a case where the printing operation is performed while the platen 20 vibrates, the distance between the inkjet head 6 and the T-shirt changes because the T-shirt held on the platen 20 also vibrates. In this case, the imaging quality deteriorates.

For this reason, in this embodiment the control unit 80 operates to wait a stopping time after the movement of the platen 20 so as to watt until the mechanical vibrations of the platen 20 stops (i.e., until the amplitude of the mechanical vibration of the platen 20 decreases to a negligible level). In this embodiment, various lengths of the stopping times are prepared because a time period for which the amplitude of the mechanical vibrations of the platen decreases to the negligible level changes depending on the type (including the shape (a size) and material) of the platen being used.

As described above, various types of the platens are prepared and the platen 20 to be attached to the supporting rod 21 is determined in accordance with, for example, the fabric to be subjected to the printing operation. More specifically, the type of the platen changes depending on, for example, a shape of the fabric, a size of the fabric (e.g., a small size, medium size, or large size), and a position at which the image is printed on the fabric. For example, the platens for printing on short-sleeve clothe, for printing on long-sleeve clothe, for printing on a pocket of cloth, for printing on a neck of cloth, and for printing on a handkerchief are prepared.

Since one of various types of material such as resin (e.g., acrylic) and metal (e.g., aluminum) can be used to form the platen, the amplitude of mechanical vibrations of the platen also changes depending on the material of the platen.

For this reason, a plurality of types of stop time tables are prepared in accordance with the type of the platen. As described above, the type of the platen being used is detected by the sensor unit 30, and the detection result of the sensor unit 30 is used by the CPU 81.

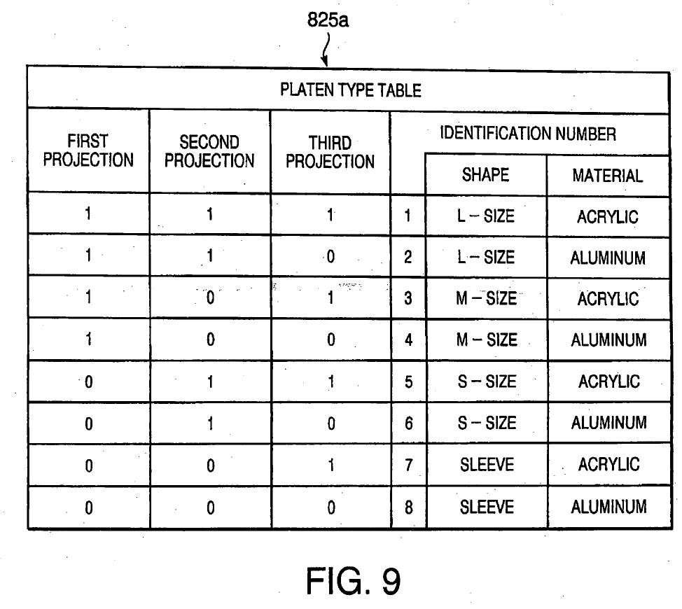

FIG. 9 shows a platen type table 825a stored in the platen type determination table storing area 825. The platen type table 825 is used to determine the type of the platen 20 attached to the supporting rod 21. The maximum number of projections 32 formed on the identification unit 31 is three in the embodiment, and the sensor unit 30 is configured to detect the existence of each of the three projections 32.

In the platen type table 825a, the three projections 32 are represented as a first projection, a second projection and a third projection, respectively. In the platen type table 825a, a value “1” represents the existence of the projection 32 and a value of “0” represents the absence of the projection 32. Depending on the existence and the absence of the projections 32, eight types (type 1-type 8) of the platen are identified. The type of the platen is indicated as identification numbers in FIG. 9.

As shown in FIG. 9, the type 1 corresponding to the detection result of first to third projections of (1,1,1) indicates that the shape is L-size (large size) and the material of the platen is acrylic. The type 2 corresponding to the detection result of (1,1,0) indicates that the shape is L-size and the material of the platen is aluminum. The type 3 corresponding to the detection result of (1,0,1) indicates that the shape is M-size (medium size) and the material of the platen is acrylic.

The type 4 corresponding to the detection result of (1.0,0) indicates that the shape is H-size and the material of the platen is aluminum. The type 5 corresponding to the detection result of (0,1,1) Indicates that the shape is S-size (small size) and the material of the platen is acrylic. The type 6 corresponding to the detection result of (0,1,0) indicates that the shape is S-size and the material of the platen is aluminum.

The type 7 corresponding to the detection result of (0,0,1) indicates that the shape of the platen is for the sleeve and the material of the platen is acrylic. The type 8 corresponding to the detection result of (0,0,0) indicates that the shape of the platen is for the sleeve and the material of the platen is aluminum.

Factors for determining the stopping time further include resolution of the image because the amount of movement of the platen 20 for the one line changes depending on the resolution of the image and: the amplitude of the mechanical vibrations of the platen (i.e., the time period for which the mechanical vibrations decrease to the negligible level) changes depending on the amount of movement of the platen.

The factors for determining the stopping time further include a printing position, at which the ink is ejected toward the platen 20, because the time period for which the amplitude of the mechanical vibrations of the plate 20 decreases to the negligible level changes depending on the distance between the printing position and the position of the supporting rod on the platen 20.

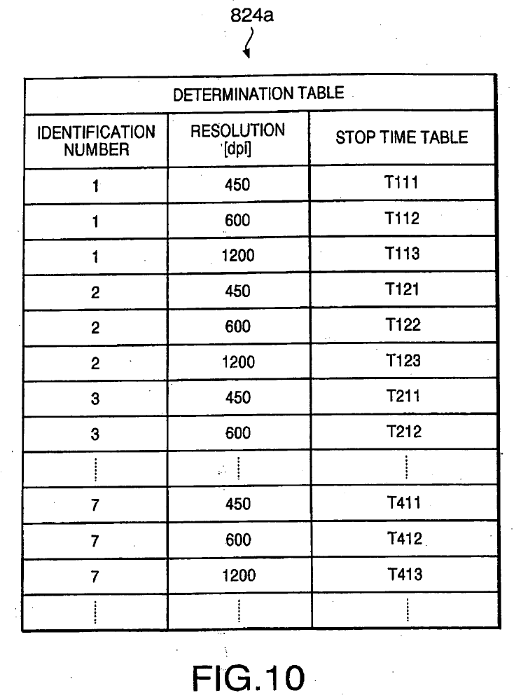

That is, the time period for which the mechanical vibrations decrease to the negligible level changes depending on the type of the platen (i.e., the shape (size) and material), the resolution of the image to be printed, the distance between the printing position and the supporting rod 21. For this reason, in this embodiment a plurality of types of stop time tables are prepared according to the type of the platen and the resolution of the image (see FIG. 10).

In each stop time table, a plurality of stopping times are prepared according to the distance between the printing position and the supporting rod 21. In this embodiment, the number of linefeeds is counted to obtain information concerning the printing position.

FIG. 10 shows an example of a determination table 824a for determining a required stop time table. As shown in FIG. 10, the stop time table to be used changes depending on the type of the platen 20 and the resolution of the image. In the example of FIG. 10, three different stop time tables are prepared depending on three kinds of resolution, for each type of the platen.

According to the determination table 824a in FIG. 10, a stop time table T111 is selected when the type of the platen (indicated as “identification number” in FIG. 10) is “1” and the resolution of the image is 450 dpi. A stop time table T112 is selected when the type of the platen is “1” and the resolution of the image is 600 dpi. A stop time table T113 is selected when the type of the platen is “1” and the resolution of the image is 1200 dpi. A stop time table T121 is selected when the type of the platen is “2” and the resolution of the image is 450 dpi.

A stop time table T411 is selected when the type of the platen is “7” and the resolution of the image is 450 dpi. A stop time table T412 is selected when the type of the platen is “7” and the resolution of the image is 600 dpi. A stop time table T413 is selected when the type of the platen is “7” and the resolution of the image is 1200 dpi.

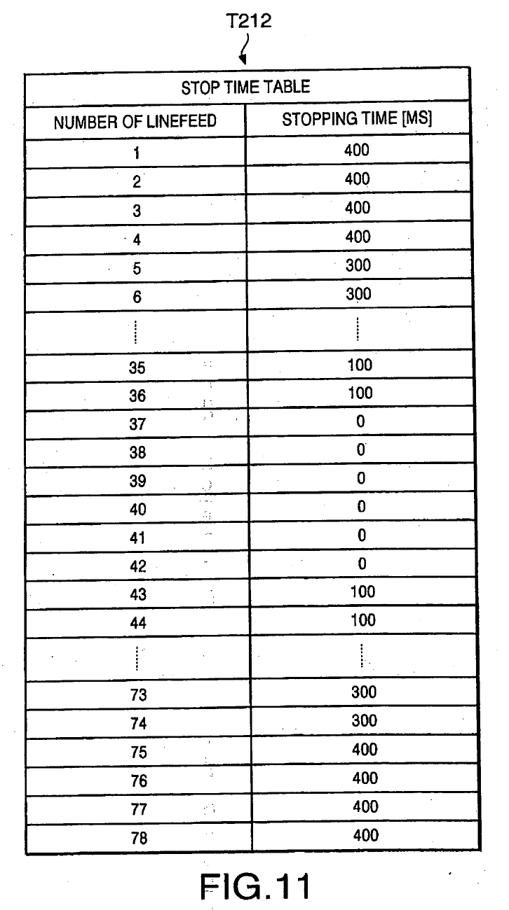

FIG. 11 shows the stop time table T212 as an example of the stop time tables. As shown in FIG. 11, the plurality of stopping times are prepared depending on the number of linefeeds. According to the example shown in FIG. 11, the stopping time is set at 400′ milliseconds when the number of linefeeds is in an range of 1 through 4, the stopping time is set at 300 ms when the number of linefeeds is 5 and 6, the stopping time is set at 0 ms when the number of linefeeds is in a range of 37 through 42, the stopping time is set at 300 Ms when the number of linefeeds is 73 and 74, and the stopping time is set at 400 ms when the number of linefeeds is in a range of 75 through 78.

The stop time table T212 of FIG. 11 is selected when the platen 20 of the type 3 is used (see FIG. 10). The platen 20 of the type 3 has the medium size, and the supporting rod 21 is situated at the position corresponding to the number of linefeeds ranging from 37 through 42. Since the mechanical vibration in the vicinity of the supporting rod (i.e., at the position corresponding to the number of linefeeds ranging from 37 through 42 on the platen 20 of the type 4) is small, the stopping time is set at 0 ms.

The stopping time increases as the distance between the printing position and the supporting rod 21 (i.e., the position corresponding to the number of linefeeds ranging from 37 through 42) increases.

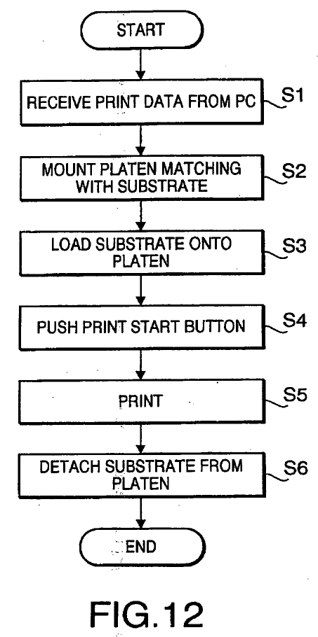

FIG. 12 is a flowchart illustrating a process of printing. Firstly, the print data is transmitted from the PC 91 to the inkjet printing device 1 (step S1). The user selects an appropriate platen from among the plurality types of platens in accordance with the fabric to be subjected to the printing operation, and mounts the selected platen on the ink-jet printing device 1 (step S2). Then, the user loads the fabric as the substrate onto the platen 20 (step S3).

When the print data is successfully received by the inkjet printing device 1, the lamp 42 is lighted and the name of received print data is indicated on the display 41. When the lamp 42 is lighted, the user pushes a print stat button (which is one of the buttons 43) to start the printing operation (step S4).

In step S5, the printing operation is performed by the inkjet printing device 1. After the printing operation is finished and the platen 20 is moved to the front end of the inkjet printing device 1, the user detaches the fabric from the platen 20 (step S6).

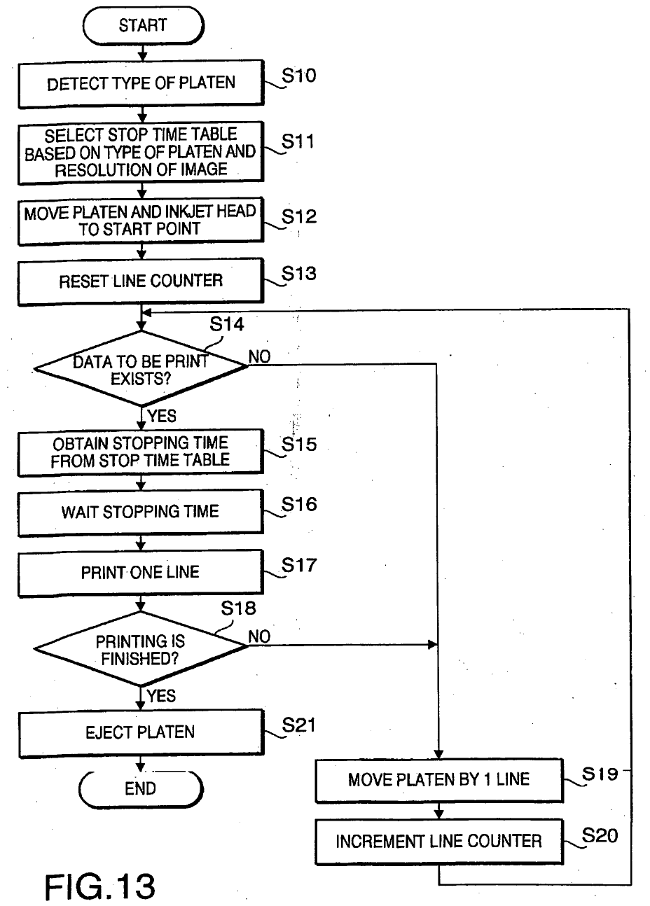

FIG. 13 is a flowchart illustrating the printing process performed by the inkjet printing device 1 under control of the control unit 80. The printing process is initiated when the user pushes the print start button. Firstly, the type of the platen 20 is determined based on the platen type table 825a using the detection result of the sensor unit 30 (step S10). For example, when the first and third projections are detected, the type of the platen 20 is determined to be the type 3.

Next, the stop time table to be used is selected based on the determination table 824a using the type of the platen 20 determined in step S10 and the resolution of the image of the received print data (step S11). For example, when the type of the platen 20 is the type 3 and the resolution of the image is 600 dpi, the stop time table T212 is selected.

Next, the platen 20 and the inkjet head 6 are moved to respective start points (step S12). Then, the count in the line counter area 832 (the line counter) is rested to “0” (step S13). In step S14, it is determined whether data to be printed exists regarding the current line. When the data to be printed on the current line does not exist (S14: NO), control proceeds to step S19 where platen 20 is moved by one line. Then, the line counter is incremented by one (S20).

When the data to be printed on the current line exists (S14: YES), control proceeds to step S15 where the stopping time is obtained from the determined stop time table. Then, the inkjet printing device 1 waits until the obtained stopping time has elapsed (S16). After the obtained stopping time has elapsed, the printing on the current line is conducted (S17). For example, when the number of linefeeds is three, the stopping time of 400 ms is obtained from the stop time table T212. After the 400 ms has elapsed, the printing on the current line is started. When the number of linefeeds is 38 and the stopping time of 0 ms is obtained from the stop time table T212, the printing on the current line is started without a wait time.

Next, it is determined whether the image is completely formed on the fabric or not (S18). When the image is not completely formed on the fabric (S18: NO), control proceeds to step S19 where the platen 20 is moved by the one line (S19). Then, the line counter is incremented by one (S20), and control returns to step S14 to continue the printing on succeeding lines.

When the image is completely formed on the fabric (S18: YES), control proceeds to step S21 where the platen is moved to an ejected position.

As described above, according to the embodiment, the type of the platen is detected automatically, and the stopping time is determined depending on the various factors including the determined type of the platen, the resolution of the image and the distance from the supporting rod 21. Therefore, the appropriate stopping time for waiting until the mechanical vibration decreases to the negligible level is secured. Consequently, the deterioration of the imaging quality due to the mechanical vibration of the platen can be prevented.

The stopping time more than necessity is not used. Therefore, the printing operation can be finished in a time period shorter than a time period required to finish printing operation in which a constant stopping time, determined to suit to the maximum distance between the printing position and the supporting rod 21, is used.

Although the present invention has been described in considerable detail with reference to certain preferred embodiments thereof, other embodiments are possible.

For example, in the above mentioned embodiment, the type of the platen is determined automatically using the identification unit 31 and the sensor unit 30; however, the type of the platen may be inputted to the inkjet printing device 1 manually. For example, the inkjet printing device may be configured such that the type of the platen is inputted by using the operation panel 40. Alternatively, the inkjet printing device may be configured such that the platen to be used is selected by the user from a menu listing the types of platens and/or information concerning the characteristics of platens displayed on the display 41.

The technique for automatically detecting the type of the platen 20 is not limited to the combination of the identification unit 31 and the sensor unit 30. For example, the inkjet printing device may be configured such that a barcode is attached to the platen and a barcode reading device is provided, for example, on the supporting rod 21 to detect the type of the platen mounted on the supporting rod 21.

Alternatively, an IC tag may be utilized to detect the type of the platen. In this case, the IC tag is attached to the platen and a reading device for reading information from the IC tag is mounted on, for example, the supporting rod 21.

Although, in the above mentioned embodiment, the unit of the amount of movement of platen is one line, the platen may be moved by a distance corresponding to a plurality of lines when successive lines without print data exist in the image to be printed. In this case, the factors for determining the stopping time may additionally include the amount of movement of the platen. That is, the stopping times may be prepared depending on the current line number at which the printing is conducted and the amount of movement of the platen required to move platen to the current line.

The amount of movement of the platen as the factor may be used in the determination table 824a in place of the resolution of the image.

It should be noted that the present invention can be applied to various types of inkjet printing device for forming images or designs onto the substrate held on a platen.

The present disclosure relates to the subject matter contained in Japanese Patent Application No. 2003-340524, filed on Sep. 30, 2003, which is expressly incorporated herein by reference in its entirety.

1. An inkjet printing device, comprising:
a holding unit that is used to hold a substrate to be subjected to printing operation;
an inkjet head that ejects ink onto the substrate held by the holding unit; and
a controller that moves the holding unit relative to the inkjet head to perform the printing operation,
wherein the controller operates to wait a predetermined stopping time after the holding unit is moved to start ejecting the ink onto the substrate held on the holding unit, the predetermined stopping time being determined depending on at least one factor that determines a time period required for mechanical vibrations of the holding unit caused by movement of the holding unit to decrease to a negligible level.

2. The inkjet printing device according to claim 1, further comprising a detecting system that detects a type of the holding unit,
wherein the at least one factor includes the type of the holding unit detected by the detecting system.

3. The inkjet printing device according to claim 2, wherein the type of the holding unit changes in accordance with a shape and material of the holding unit.

4. The inkjet printing device according to claim 1, further comprising a supporting member that is used to support the holding unit,
wherein the at least one factor includes a distance between a printing position at which the ink is ejected toward the holding unit and a position of the supporting member on the holding unit.

5. The inkjet printing device according to claim 1, wherein the at least one factor includes an amount of movement of the holding unit.

6. The inkjet printing device according to claim 1, wherein the controller operates to move the holding unit by a distance corresponding to one line of an image to be printed each time printing of one of lines of the image is completed, the controller waiting the predetermined time period after the holding unit is moved by the distance corresponding to the one line.

7. The inkjet printing device according to claim 6,
wherein the distance corresponding to the one line changes depending on resolution of the image to be printed, and
wherein the at least one factor includes the resolution of the image.

8. The inkjet printing device according to claim 1, wherein the controller has a time table in which a plurality of stopping times are defined, the plurality of stopping times being associated with the at least one factor so that the controller selects one of the stopping times as the predetermined stopping time in accordance with the at least one factor.

9. The inkjet printing device according to claim 1, further comprising an operation panel that has buttons for inputting information to the controller,
wherein the at least one factor is inputted to the controller manually by use of the operation panel.

10. A method of printing an image on a substrate held on a holding unit provided in an inkjet printing device, comprising the steps of:
moving the holding unit relative to an inkjet head;
determining a stopping time depending on at least one factor that determines a time period reguired for mechanical vibrations of the holding unit caused by movement of the holding unit to decrease to a negligible level;
waiting the stopping time after the holding unit is moved in the moving step; and
starting to eject ink on the substrate held on the holding unit after the stopping time has elapsed in the waiting step.

11. A method of printing an image on a substrate held on a holding unit detachably attached to an inkjet printing device, comprising the steps of:
detecting a type of the holding unit attached to the ink-jet printing device;
moving the holding unit relative to an inkjet head;
determining a stopping time depending on at least one factor that determines a time period required for mechanical vibrations of the holding unit caused by movement of the holding unit to decrease to a negligible level;
waiting the predetermined stopping time after the holding unit is moved in the moving step; and
starting to eject ink on the substrate held on the holding unit after the stopping time has elapsed in the waiting step,
wherein the at least one factor includes the type of the holding unit detected by the detecting step.
